(19) United States
(12) Patent Application Publication
(10) Pub. No.: US 2007/0223769 A1
(43) Pub. Date: Sep. 27, 2007

(54) Speaker and method making the same

(75) Inventor: Jui-Cheng Chang, Taichung City (TW)

Correspondence Address: BIRCH STEWART KOLASCH & BIRCH, PO BOX 747, FALLS CHURCH, VA, 22040-0747, US

(73) Assignee: MERRY ELECTRONICS CO., LTD.

(21) Appl. No.: 11/384,281

(22) Filed: Mar. 21, 2006

(51) Int. Cl. H04R 9/06

(52) U.S. Cl. 381/396

(57) ABSTRACT

A speaker includes a yoke, a diaphragm, an electrode plate, a magnet and a lower plate. The yoke includes a base, a wall and a terminal plate connected integrally to each other. The wall has a chamber and is mounted on the base. The rest components are mounted in the chamber. An amount of the components of the speaker is reduced because of the integral connection among the base and the wall. Consequently, the manufacturing costs and assembly process will be lowered and simplified.

### BACKGROUND

1. Field of Invention

The present invention relates to a speaker, and more particularly to a small type speaker and the speaker has minimized components.

2. Description of Related Art

The operational function of a speaker is to transform electric signals into audio signals. Speakers are important output components for electric products, and can be integrated into many kinds of earphones or headsets, such as walkman, audio, radio, multimedia devices, recorders or portable digital dictionaries. Speakers also could be assembled into handsets for making phone calls.

Speakers have different structures and sizes for different purposes. Among them are used in various earphones or walkmans, and the speakers are the small type speakers.

Reference is made to FIG. 1, which illustrates an exploded perspective view of a conventional speaker. A speaker 100 comprises a front cover 110, a diaphragm 120, a voice coil 130, an electrode plate 140, a magnet 150, a plastic yoke 160, a terminal plate 170 and a lower plate 180.

The plastic yoke 160 provides a slot 161 for holding a terminal part 171 of the terminal plate 170 and a middle hole 162 in which the lower plate 180 is mounted. The lower plate 180 is like a tub and makes the plastic yoke 160 have a chamber 163 (Reference is made to FIG. 2). And the terminal part 171 has a terminal 172 for connecting power cord. Hence, The magnet 150, the electrode plate 140 and the voice coil 130 could be mounted and held in the chamber 163 in sequence. Lastly, putting the diaphragm 120 and covering the front cover 110 into the chamber 163 complete a small type speaker (Reference is made to FIG. 3).

The above-mentioned speaker 100 needs several components and manufacturing processes. The cost and manufacturing processes of fabricating the speakers 100 are generally high. Since the speakers 100 are demanded in mass production, the cost accumulated is considerable.

### SUMMARY

An objective of the present invention is to provide a speaker which could moderately reduce some components to lower the manufacturing costs of the speaker.

Another objective of the present invention is to provide a speaker that is small in size for the demands of being mounted in those thin, light and short electric instruments.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is an exploded perspective view of a conventional speaker;

FIG. 2 is a perspective view of a plastic yoke and terminal plate of the speaker in FIG. 1;

FIG. 3 is a cross-sectional view of the speaker in FIG. 1;

FIG. 4 is an exploded perspective view of a speaker of the preferred embodiment in accordance with the present invention;

FIG. 5 is a perspective view of a terminal plate of the speaker in FIG. 4;

FIG. 6 is a cross-sectional view of the speaker in FIG. 4; and

FIG. 7 is a perspective view of the speaker in FIG. 4.

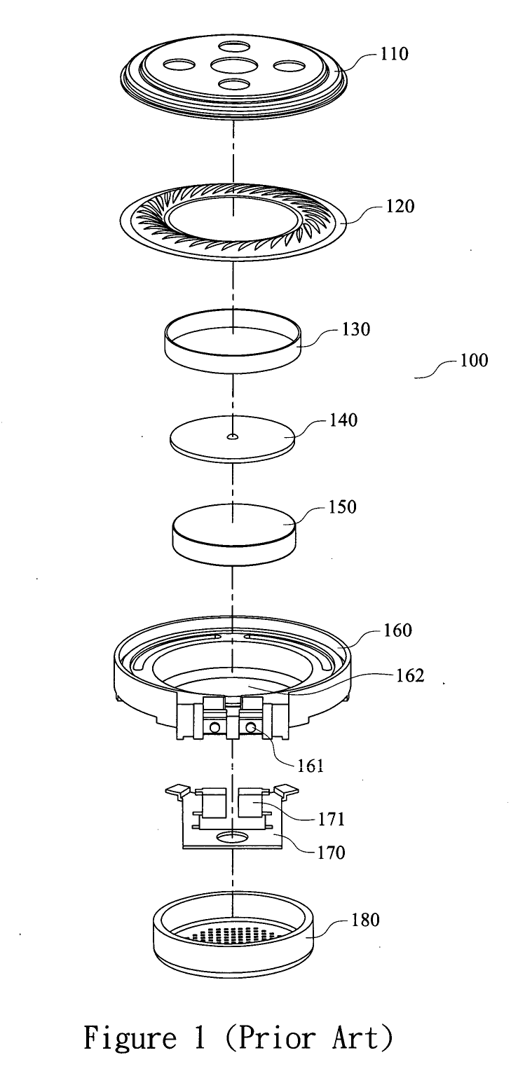

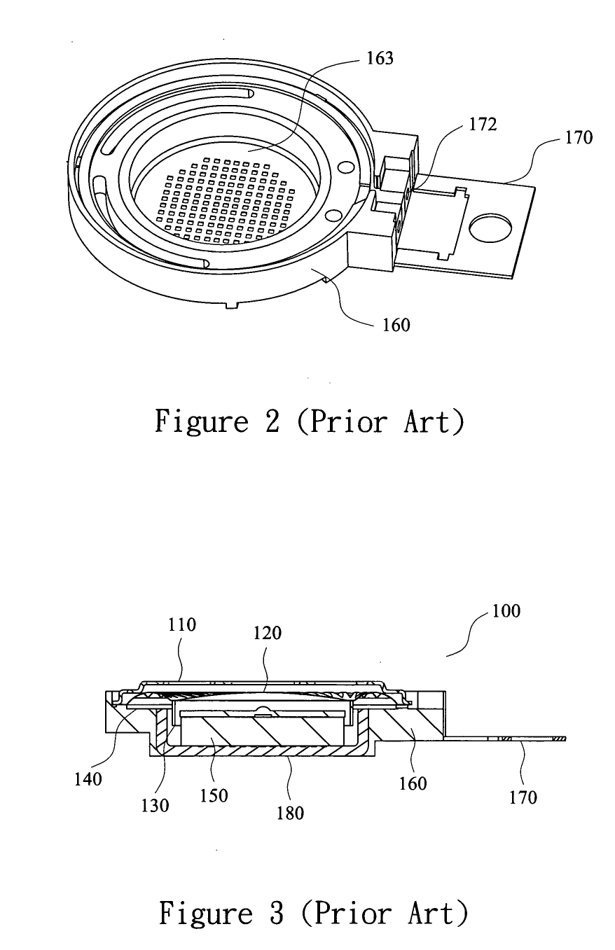

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as original, it is believed that the invention is better understood from a consideration of the following description in conjunction with the figures, in which like reference numerals are carried forward.

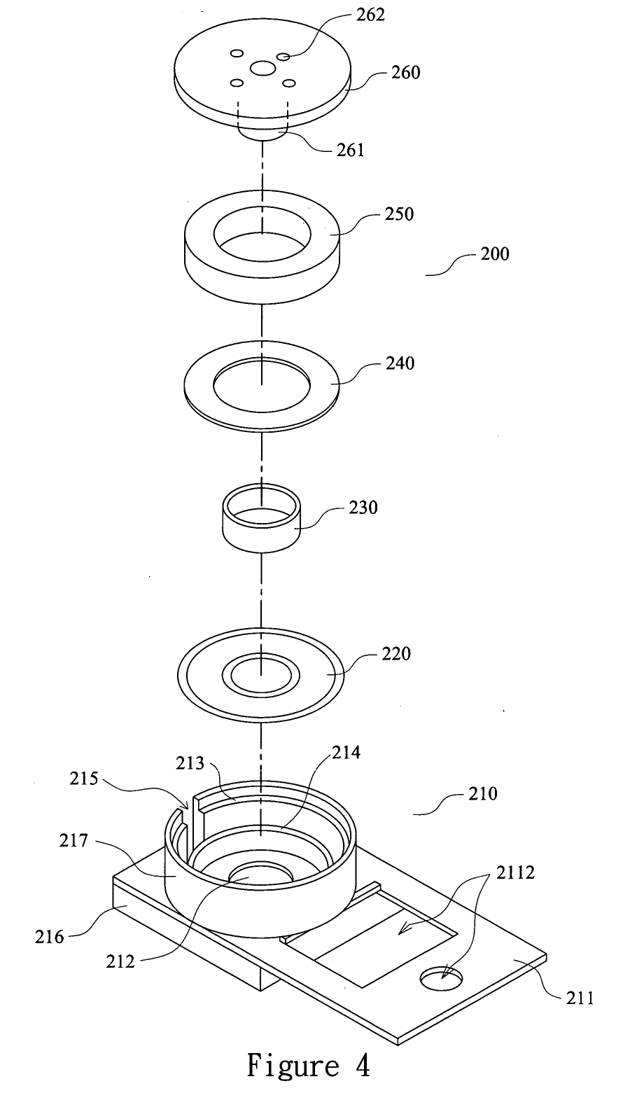

Reference is made to FIG. 4, which illustrates an exploded perspective view of a speaker of the preferred embodiment in accordance with the present invention (In order to express the accurate structure of the speaker and apt to describe it, the present invention's figures illustrates in opposite orientation to prior art). A speaker 200 comprises a yoke 210, a diaphragm 220, a voice coil 230, an electrode plate 240, a magnet 250 and a lower plate 260.

The yoke 210 comprises a terminal plate 211, a base 216 and a wall 217. The base 216 and the wall 217 are made of insulating material, such as plastic.

The wall 217 is integrally mounted on the base 216 and can be a ring, a chamber is defined inside the wall 217. The wall 217 has a first step 213 and a second step 214 formed inside the chamber and a gap 215 defined in the wall 217.

The terminal plate 211 is mounted on the base 216 for connecting a power cord. The base 216 has an acoustic hole 212. The acoustic hole 212 is defined completely through the base 216 and communicates with the chamber of the wall 217. The base 216 has four corners extended out of the edge of the wall 217 onto which the terminal plate 211 is mounted.

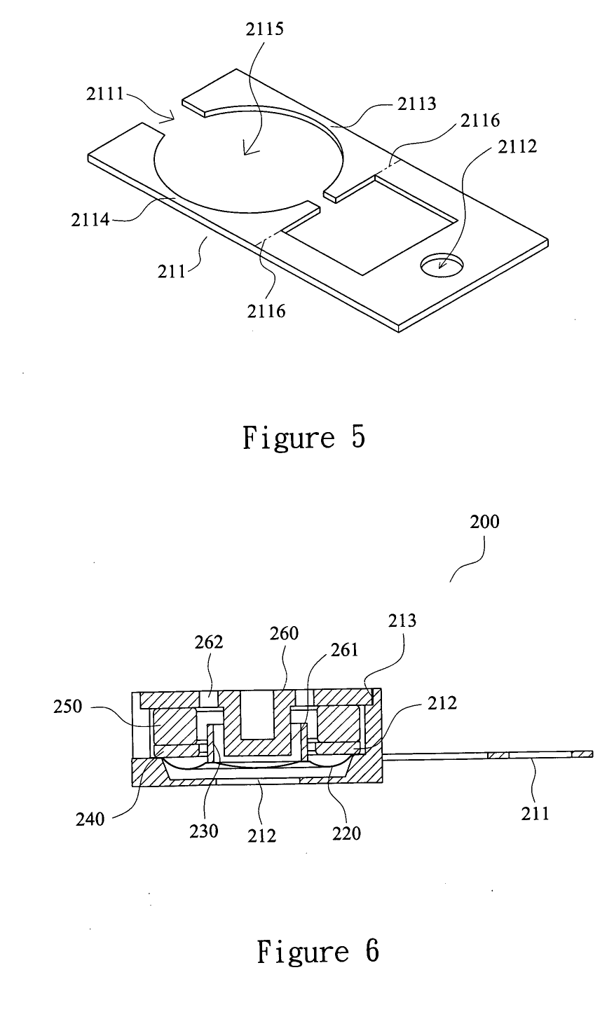

Reference is made to FIG. 4 and FIG. 5, which illustrate the terminal plate 211 of the preferred embodiment in accordance with the present invention. The terminal plate 211 includes a first connecting zone 2113, a second connecting zone 2114 and at least one molding hole 2112. The first connecting zone 2113 and the second connecting zone 2114 are generally “C” shaped and are arranged opposite to each other. Therefore, a gap 2111 and a through hole 2115 are defined between the first connecting zone 2113 and the second connecting zone 2114. The terminal plate 211 has a parting line 2116 which is preformed adjacent to the first connecting zone 2113 and the second connecting zone 2114 of the terminal plate 211. The first connecting zone 2113 and the second connecting zone 2114 can be separated from each other by breaking a part of the terminal plate 211 along the parting line 2116.

The terminal plate 211 can integrally be mounted with the base 216 and the wall 217 during the process of molding the base 216 and the wall 217. The wall 217 passes through and is held in the through hole 2115. The first connecting zone 2113 and the second connecting zone 2114 are mounted on the opposite pairs of corners of the base 216 respectively. Wires of the voice coil 230 could be connected to the zones 2113, 2114 of the terminal plate 211 via the gap 215 respectively. Hence, no additional terminals on the outer side of the wall 217 are needed, which could reduce the entire working height of the speaker. This speaker can be made small to meet the demands for speakers assembled into light, thin, short and small devices.

Reference is made to FIG. 4 and FIG. 6 (FIG. 6 is a cross-sectional view of a speaker of the preferred embodiment in accordance with the present invention).

The diaphragm 220 is also called a vibrating film and could be made by paper, plastic or metallic materials. The edge of the diaphragm 220 could be connected to the second step 214 of the yoke 210. The voice coil 230 connects to the diaphragm 220. When the voice coil 230 vibrates, it could make the diaphragm 220 vibrate simultaneously, the vibration of the air around the diaphragm 220 turns into sound vibrations

The wires of the voice coil 230 pass through the gap 215 of the yoke 210 and connect to the terminal plate 211. When the voice coil 230 is energized, the metal wire could generate an electromagnetic field, and the strength of the electromagnetic field and the field of the magnet 250 are about the same. The positive pole and the negative pole of the coil exchange continuously, which changes the magnetic field of the coil and makes the coil shift forward and backward to cause the diaphragm 220 to vibrate and make sound.

The magnet 250 and the electrode plate 240 are mounted in the chamber of the yoke 210 inside the wall 217. The magnet 250 is a permanent magnet, which forms a permanent magnetic field. When the current passes through the voice coil 230, the permanent field and the field of the voice coil 230 will be attractive or repulsive to each other; when the direction of current changes, so does the direction of the magnetic field; namely each time the direction of current changes, the voice coil 230 will produce a vibration.

The lower plate 260 includes a protruding pole 261 that could pass through the voice coil 230, and the lower plate 260 includes an air hole 262. The air hole 262 could be a single hole or a plurality of holes. The lower plate 260 could be mounted against the first step 213 of the yoke 210 by a fastening means such as glue or solder. This results in the diaphragm 220, the voice coil 230, the electrode plate 240, the magnet 250 and the lower plate 260 being assembled into the yoke 210 to form the speaker 200.

If any component needs to be disassembled, opening the lower plate 260 first, then the diaphragm 220, the voice coil 230, the electrode plate 240 and the magnet 250 can be removed without having to break the soldered voice coil 230 wire.

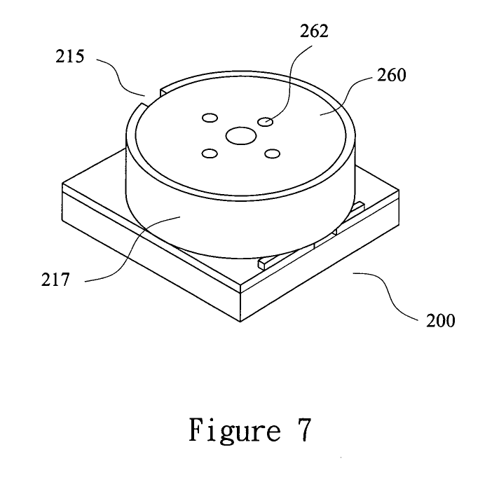

Reference is made to FIG. 5 and FIG. 7. FIG. 7 illustrates an perspective view of a speaker of the preferred embodiment in accordance with the present invention. After the terminal plate 211, the base 216 and the wall 217 are assembled together, a part of the terminal plate 211 is cut along the parting line 2116. Therefore, the first connecting zone 2113 and the second connecting zone 2114 are separated and insulated electrically from each other.

Therefore, the assembling process of the speaker is an inverse operation comparing to that of the conventional speaker. The diaphragm 220 is mounted into the yoke 210. The voice coil 230 is mounted into the yoke 210 and connected to the diaphragm 210. The electrode plate 240, the magnet 250 and the lower plate 260 are mounted to the speaker yoke 210 in sequence. The speaker in accordance with the present invention is easier to assemble than conventional speaker because of the inverse assembling process.

According to the composition and the embodiments above, there are many advantages of the present invention over the prior art, such as:

1. The yoke and the terminal plate are assembled simultaneously, which will reduce the components and lower the costs.

2. The terminal plate is mounted on the corners of the base so that the size and volume of the entire yoke is efficiently reduced.

3. The corresponding “C” shaped connecting zones of the metal terminal plate are covered by the yoke, which makes the yoke more solid, and the strength and durability of the speaker also increase obviously.

4. Because the terminal plate and the yoke are assembled together, the strength and the reliability among those components will be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speaker comprising:
a yoke comprising a base, a wall and a terminal plate connected integrally to each other, the wall having a chamber and mounted on the base, the base having a plurality of corners extending out of the wall and at least one acoustic hole communicating with the chamber, and the terminal plate mounted and supported on the corners of the base;
a diaphragm mounted in the chamber;
a voice coil mounted in the chamber and connected with the diaphragm;
an electrode plate and a magnet mounted in the chamber; and
a lower plate, covering the chamber, the lower plate having at least one air hole.

2. The speaker of claim 1, wherein the yoke is made of insulating material.

3. The speaker of claim 1, wherein the terminal plate is made of conducting material.

4. The speaker of claim 1, wherein the wall has a gap.

5. The speaker of claim 1, wherein the lower plate includes a protruding pole.

6. The speaker of claim 1, wherein the base comprises four corners;
the terminal plate having a first connecting zone and a second connecting zone mounted respectively on opposite pairs of the corners, and separated and insulated electrically from each other.

7. The speaker of claim 6, wherein each of the first connecting zone and the second connecting zone is “C” shaped.

8. A method for manufacturing a speaker, the method comprising:
providing a yoke having an integrated base and wall, wherein the wall has a chamber;
mounting a terminal plate to the base outside the wall;
mounting a diaphragm into the chamber;
mounting a voice coil into the chamber and connecting to the diaphragm;
mounting an electrode plate into the chamber;
mounting a magnet into the chamber; and
attaching a lower plate to the wall to cover the chamber.
